(19) United States
(12) Patent Application Publication
(10) Pub. No.: US 2022/0274514 A1
(43) Pub. Date: Sep. 1, 2022

(54) SEAT AIR CONDITIONER

(71) Applicant: DENSO CORPORATION, Kariya-City (JP)

(72) Inventors: Takahisa FUJII, Kariya-City (JP); Shuji ITO, Kariya-City (JP); Hironobu MURAKAMI, Kariya-City (JP); Masafumi KAWASHIMA, Kariya-City (JP)

(21) Appl. No.: 17/747,237

(22) Filed: May 18, 2022

Related U.S. Application Data
(63) Continuation of application No. PCT/JP2020/047493, filed on Dec. 18, 2020.

(30) Foreign Application Priority Data
Jan. 8, 2020 (JP) 2020-001703

(51) Int. Cl. B60N 2/56

(52) U.S. Cl. CPC B60N 2/5657; B60N 2/5628

(57) ABSTRACT

A seat air conditioner includes a blower and a seat back. The seat back includes: a cover, which is air-permeable, and a back pad having a plurality of ventilation holes through which an air flow generated by the blower passes. A ventilation passage is connected to the plurality of ventilation holes. When a part of the seat back exposed to a person is evenly divided into a first back portion, a second back portion, a third back portion, a fourth back portion, a fifth back portion and a sixth back portion in this order from a lower side, the back pad has a thoracic spine corresponding portion corresponding to the third back portion and the fourth back portion. An area occupied by the ventilation holes per unit area in the thoracic spine corresponding portion is larger than that in a portion other than the thoracic spine corresponding portion.

### CROSS REFERENCE TO RELATED APPLICATION

The present application is a continuation application of International Patent Application No. PCT/JP2020/047493 filed on Dec. 18, 2020, which designated the U.S. and claims the benefit of priority from Japanese Patent Application No. 2020-001703 filed on Jan. 8, 2020. The entire disclosures of all of the above applications are incorporated herein by reference.

### TECHNICAL FIELD

The present disclosure relates to a seat air conditioner.

### BACKGROUND

Conventionally, a seat air conditioner is provided for ventilating a seat surface of a seat back. The seat back has ventilation holes at position to support a person.

### SUMMARY

According to an aspect of the present disclosure, a seat air conditioner includes: a blower configured to generate an air flow; and a seat back configured to support an upper body of a person. The seat back includes: a cover, which is air-permeable, arranged on a front side to support the upper body of the person, and a back pad having a plurality of ventilation holes on the front side through which the air flow generated by the blower passes, and a ventilation passage connected to the plurality of ventilation holes. When a part of the seat back exposed to the person is evenly divided into a first back portion, a second back portion, a third back portion, a fourth back portion, a fifth back portion and a sixth back portion in this order from a lower side, the back pad has a thoracic spine corresponding portion corresponding to the third back portion and the fourth back portion. An area occupied by the ventilation hole per unit area in the thoracic spine corresponding portion is larger than an area occupied by the ventilation hole in a portion other than the thoracic spine corresponding portion.

### BRIEF DESCRIPTION OF DRAWINGS

FIG. 1 is a schematic view showing a seat back of a seat air conditioner according to a first embodiment.

FIG. 2 is a schematic view showing a seat, on which an AM50% ile dummy is seated and to which the seat air conditioner of the first embodiment is applied.

FIG. 3 is a schematic perspective view of the seat back according to the first embodiment.

FIG. 4 is a schematic front view illustrating a back pad of the seat back according to the first embodiment.

FIG. 5 is a diagram for explaining a pressure distribution on the seat back when the dummy is seated.

FIG. 6 is a diagram for explaining a cold spot distribution of a body.

FIG. 7 is a diagram for explaining a sweating rate of a body.

FIG. 8 is a schematic front view showing a back pad of a seat back according to a second embodiment.

FIG. 9 is a schematic front view showing a modification of the back pad of the second embodiment.

FIG. 10 is a schematic view showing a modification of a seat back of a seat air conditioner.

### DESCRIPTION OF EMBODIMENTS

To begin with, examples of relevant techniques will be described.

Conventionally, a seat air conditioner is provided for ventilating a seat surface with respect to a seat back. The seat back has ventilation holes formed in the entire portion of the back pad that supports a person, so as to ventilate substantially the entire surface of the seat.

However, it is inefficient if such a structure that ventilates substantially the entire surface of the seat cools the vicinity of a part of the body that is insensitive to cold. This is found after the studies by the present inventors. The present disclosure provides a seat air conditioner capable of efficiently giving comfort to a person.

According to an aspect of the present disclosure, a seat air conditioner includes: a blower configured to generate an air flow; and a seat back configured to support an upper body of a person. The seat back includes: a cover, which is air-permeable, arranged on a front side to support the upper body of the person, and a back pad having a plurality of ventilation holes on the front side through which the air flow generated by the blower passes, and a ventilation passage connected to the plurality of ventilation holes. When a part of the seat back exposed to the person is evenly divided into a first back portion, a second back portion, a third back portion, a fourth back portion, a fifth back portion and a sixth back portion in this order from a lower side, the back pad has a thoracic spine corresponding portion corresponding to the third back portion and the fourth back portion. An area occupied by the ventilation hole per unit area in the thoracic spine corresponding portion is larger than an area occupied by the ventilation hole in a portion other than the thoracic spine corresponding portion.

Accordingly, the ventilation capacity is raised in the third back portion and the fourth back portion corresponding to the thoracic spine where the cold spot density and the sweating rate of the body are high. The seat pressure is low at the third back portion and the fourth back portion, compared with the second back portion corresponding to a waist of the body where the cold spot density and the sweating rate of the body are high as in the thoracic spine, so that the distribution of the air flow is not easily obstructed at the third back portion and the fourth back portion. Thus, it is possible to efficiently give comfort to the person on the seat.

According to another aspect of the present disclosure, a seat air conditioner includes: a blower configured to generate an air flow; and a seat back configured to support an upper body of a person. The seat back includes: a cover, which is air-permeable, arranged on a front side to support the upper body of the person; and a back pad having a plurality of ventilation holes on the front side through which the air flow generated by the blower passes, and a ventilation passage connected to the plurality of ventilation holes. When an upper body of an AM50% ile dummy, which is a human body model of the person, is supported by the seat back, the back pad has a thoracic spine corresponding portion corresponding to a lower part of a shoulder to an upper part of a waist of the dummy. An area occupied by the ventilation hole per unit area in the thoracic spine corresponding portion is larger than an area occupied by the ventilation hole in a portion other than the thoracic spine corresponding portion.

Accordingly, the ventilation capacity is raised at the position supporting the thoracic spine in an area from the lower part of the shoulder to the upper part of the waist where the cold spot density and the sweating rate of the body are high. The seat pressure is low in the area corresponding to the thoracic spine from the lower part of the shoulder to the upper part of the waist, compared with the waist where the cold spot density and the sweating rate of the body are high as in the thoracic spine. Since the distribution of the air flow is not easily obstructed when the seat pressure is low, it is possible to efficiently give comfort to the person on the seat.

A reference numeral attached to each component or the like indicates an example of correspondence between the component or the like and specific component or the like described in embodiments below.

Hereinafter, embodiments of the present disclosure will be described with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. The following embodiments may be partially combined with each other even if such a combination is not explicitly described as long as there is no disadvantage with respect to such a combination.

### First Embodiment

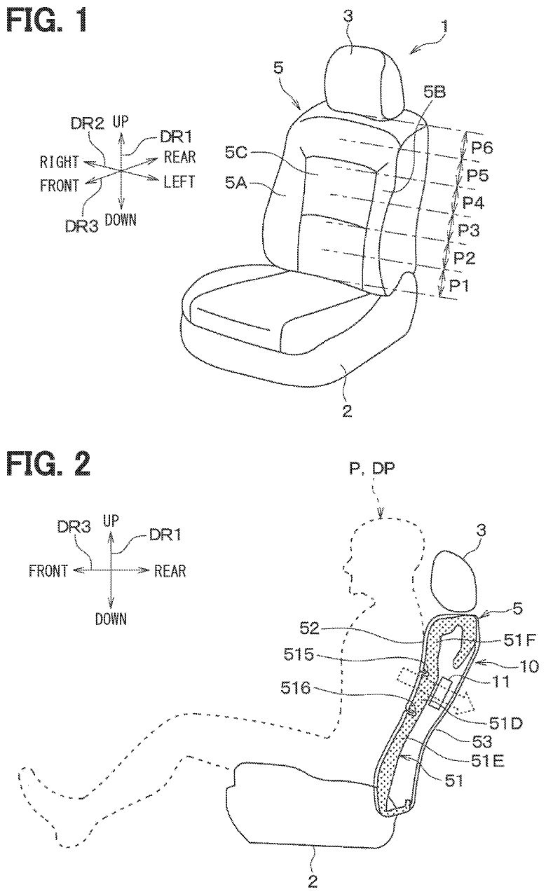

A first embodiment of the present disclosure will be described with reference to FIGS. 1 to 7. In this embodiment, a seat air conditioner 10 is applied to a seat 1 installed as a front seat in a vehicle such as automobile. Directions DR1, DR2, and DR3 in the drawings are shown for easy understanding of the relationship among the drawings. The directions DR1, DR2, and DR3 indicate respectively up/down direction, left/right direction, and front/rear direction in a state where the seat 1 is installed in the automobile. The installation state of the seat air conditioner 10 and the like of the present disclosure is not limited to the direction shown in each of the drawings.

As shown in FIGS. 1 and 2, the seat 1 includes a seat cushion 2 on which a person P is seated, a headrest 3 that supports the head of the person P, and a seat back 5 that serves as a backrest for the person P. The person P is a user of the seat 1, and includes a person who is not actually seated on the seat 1. The person P shown in the drawings is an AM50% ile dummy DP. The AM50% ile dummy DP is a 50th percentile dummy doll of an American adult male.

The seat cushion 2 supports the lower body of the person P. Specifically, the seat cushion 2 mainly supports the buttocks. Although not shown, the seat cushion 2 has a cushion pad, a cover, and the like. The cushion pad is a cushioning material made of an elastically deformable material such as urethane foam. The cover is a member that covers the front side of the cushion pad.

The headrest 3 supports the head of the person P. Although not shown, the headrest 3 has a head pad, a cover, and the like. The head pad is a cushioning material made of an elastically deformable material such as urethane foam. The cover is a member that covers the front side of the head pad.

The seat back 5 supports the upper body of the person P excluding the head. In the present embodiment, a part of the seat back 5 exposed to the person P is evenly divided into six parts, e.g., the first back portion P1, the second back portion P2, the third back portion P3, the fourth back portion P4, the fifth back portion P5, and the sixth back portion P6 in this order from the lower side.

In the seat back 5, the first back portion P1 is a support portion that supports the buttocks of the body, and the second back portion P2 is a support portion that supports the waist (lumber) of the body. Further, the third back portion P3 and the fourth back portion P4 is a support portion that supports the thoracic spine of the body. The fifth back portion P5 is a support portion that supports the shoulder of the body, and the sixth back portion P6 is a support portion that supports the cervical spine of the body. The thoracic spine of the body corresponds the body from the lower part of the shoulder to the upper part of the waist in the dummy DP. Further, the shoulder of the body is assumed to be, for example, a range from the clavicle to the scapula-brachial joint located at the upper end of the scapula in the dummy DP.

The lower end of the seat back 5 is connected to the rear end of the seat cushion 2 via a reclining mechanism (not shown). Further, the headrest 3 is connected to the upper end of the seat back 5. As shown in FIG. 2, the seat back has a back pad 51, a cover 52, and a back frame 53.

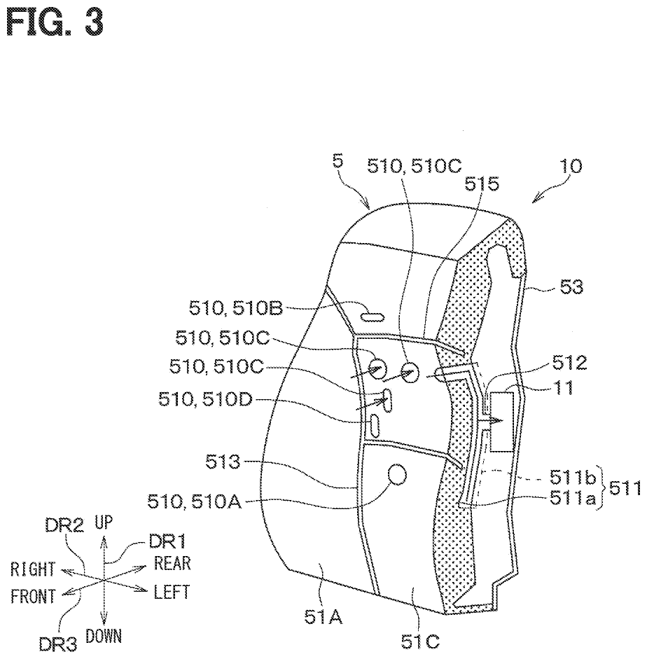

The back pad 51 is a cushioning material made of an elastically deformable material such as urethane foam. As shown in FIG. 3, the back pad 51 has ventilation holes 510 on the front side through which the air flow generated by the blower 11 passes. The ventilation hole 510 is a through hole penetrating the back pad 51 between the front side and the rear side. The formation positions of the ventilation holes 510 will be described later.

The back side of the back pad 51 has a ventilation passage 511 connected with the ventilation holes 510. The ventilation passage 511 is composed of a ventilation groove 511a formed on the back side of the back pad 51 and a sealing member 511b that covers the ventilation groove 511a from the back side of the back pad 51. The sealing member 511b is made of, for example, felt.

The ventilation passage 511 is connected to a manifold 512 formed on the back side of the back pad 51. The manifold 512 is a space that collects the air flowing through the ventilation passages 511 and guides the air to the blower 11.

As shown in FIG. 1, the seat back 5 has side supports 5A and 5B that support the person P in the width direction of the seat back 5, and a center support 5C arranged between the side supports 5A and 5B. The side supports 5A and 5B project toward the person P than the center support 5C so that the person P can be supported in the width direction of the seat back 5.

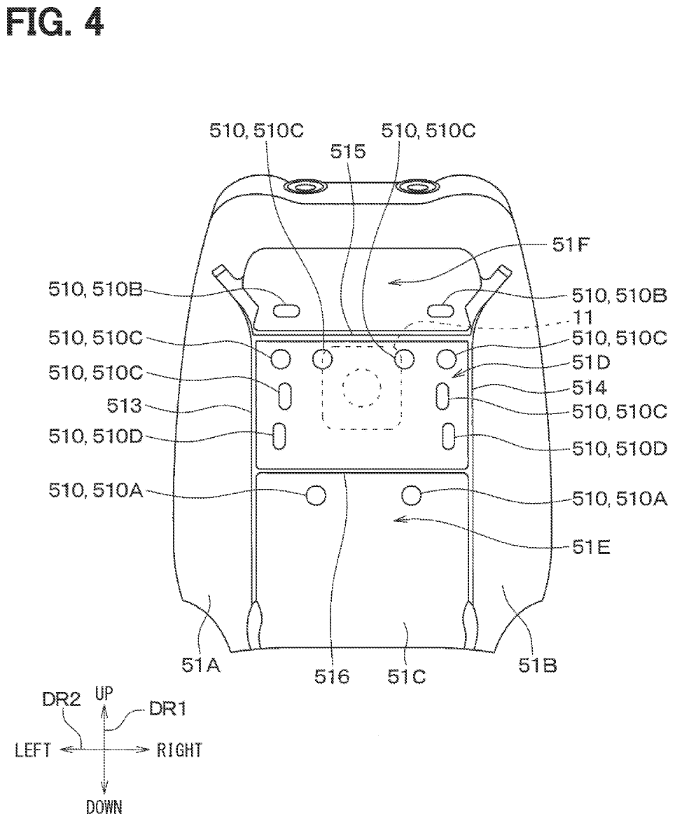

As shown in FIG. 4, the back pad 51 has side portions 51A and 51B corresponding to the side supports 5A and 5B, and a center portion 51C corresponding to the center support 5C.

The front side of the back pad 51 has vertical suspension grooves 513 and 514, and lateral suspension grooves 515 and 516 intersecting the vertical suspension grooves 513 and 514. The vertical suspension grooves 513, 514 and the lateral suspension grooves 515, 516 receive the seams of the cover 52.

The vertical suspension groove 513, 514 is formed between the side portion 51A, 51B and the center portion 51C so as not to affect the comfort of the person P. The vertical suspension grooves 513 and 514 extend upward from the lower end of the back pad 51.

The lateral suspension grooves 515 and 516 are provided, so as not to affect the comfort of the seat 1, at a position corresponding to the vicinity of the lower part of the shoulder and a position corresponding to the vicinity of the upper part of the waist of the person P. In other words, the lateral suspension groove 515 is set between the fourth back portion P4 and the fifth back portion P5, and the lateral suspension groove 516 is set between the second back portion P2 and the third back portion P3 in the seat back 5. The lateral suspension groove 515, 516 extends from one of the vertical suspension grooves 513 and 514 to the other so as to be substantially orthogonal to the vertical suspension groove 513, 514.

The cover 52 is a member that covers the front side of the back pad 51. Specifically, the cover 52 is arranged on the front side of the seat back 5 which is a support surface for supporting the upper body of the person P. The cover 52 is made of a breathable material.

The back frame 53 is a frame-shaped member forming the skeleton of the seat back 5. The back pad 51 is attached to the back frame 53. An installation space for installing the blower 11 and the like, which will be described later, is formed between the back frame 53 and the back pad 51. Lumber support may be added to the back frame 53. The lumbar support keeps the body near the waist and optimizes the posture.

The seat air conditioner 10 is configured as a seat ventilation system (SVS) that directly cools the human body by blowing air from the seat 1. The seat air conditioner 10 includes the seat back 5 and the blower 11.

The blower 11 is arranged between the back frame 53 and the back pad 51. The blower 11 is fixed to the back frame 53. Specifically, the blower 11 is arranged at a position where at least a part of the blower 11 overlaps a thoracic spine corresponding portion 51D, which is described later, in the thickness direction of the seat back 5. In other words, the blower 11 is arranged in an area on the back side of the back pad 51 where the ventilation holes 510 occupy a relatively large area.

The blower 11 is connected to the manifold 512. When the blower 11 is driven, the air flow passes through the manifold 512. Specifically, an air suction port of the blower 11 is connected to the manifold 512.

In the seat air conditioner 10, the blower 11 sucks air from the manifold 512, so that the air flow generated by the blower 11 passes through the ventilation holes 510. In the seat air conditioner 10 configured in this way, if substantially the entire surface of the seat back 5 is ventilated as in a comparison example, the vicinity of the cold-insensitive portion of the body of the person P is also ventilated, which is inefficient.

In contrast, in the seat air conditioner 10 of the present embodiment, the formation positions of the ventilation holes 510 are set in consideration of the distribution of the seat pressure of the back pad 51, the distribution of the cold spot density of the body of the person P, and the distribution of the sweating rate. Hereinafter, the distribution of the seat pressure of the back pad 51, the distribution of the cold spot density of the body of the person P, and the distribution of the sweating rate will be described, and then the formation position of the ventilation hole 510 will be described.

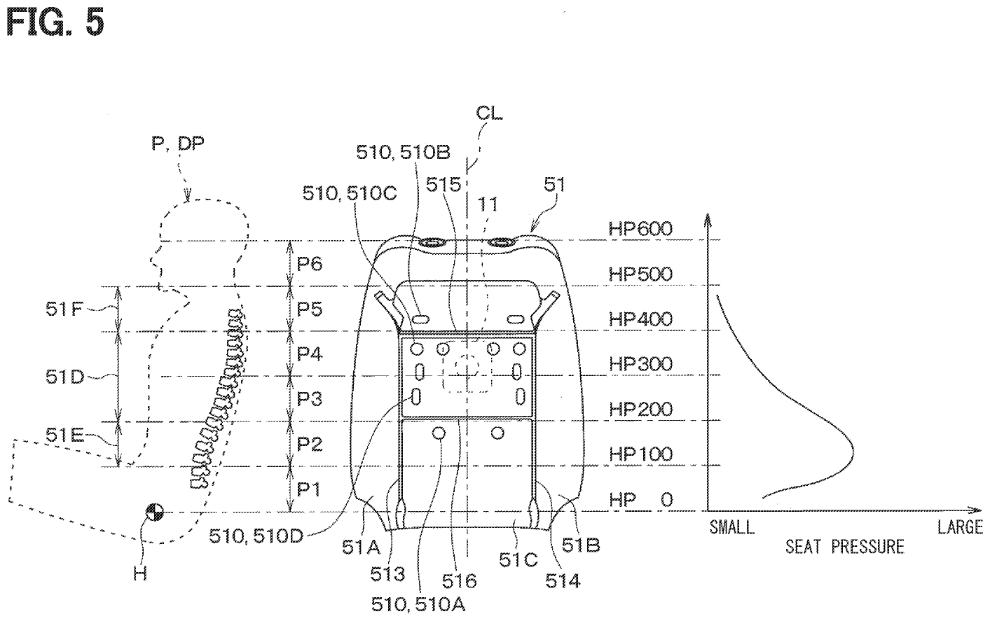

When the person P is seated on the seat 1 in a standard posture, the pressure acting on a part of the seat back 5 exposed to the person P is not uniform throughout the back pad 51. That is, the seat pressure is not uniform throughout the back pad 51. As shown in FIG. 5, the seat pressure of the back pad 51 is maximum in a range from HP100 to HP200, where the distance from the hip point H of the person P is 100 mm to 200 mm.

The person P and the back pad 51 are in close contact with each other in the vicinity of HP100 to HP200 on the front side of the back pad 51. Since the back pad 51 is likely to be deformed in the vicinity of HP100 to HP200, the flow of air in the ventilation hole 510 and the ventilation passage 511 is likely to be obstructed.

The seat pressure of the back pad 51 is relatively small in a range where the distance from the hip point H of the person P is 400 mm or more. In particular, when the distance from the hip point H of the person P is 500 mm or more, the seat pressure becomes substantially zero since the body of the person P is separated from the seat back 5.

In the range where the distance from the hip point H of the person P is 400 mm or more, the seat pressure is small and the ventilation hole 510 of the back pad 51 and the person P are easily separated from each other. Thus, the air flow generated by the blower 11 is easily separated from the person P. That is, in the range where the distance from the hip point H of the person P is 400 mm or more, it is difficult to obtain comfort by ventilation since the air flow generated by the blower 11 is away from the person P, although the flow of the air in the ventilation hole 510 and the ventilation passage 511 is not easily obstructed. The range in which the distance from the hip point H of the person P is 400 mm to 600 mm corresponds to HP400 to HP600 shown in FIG. 5.

Therefore, from the viewpoint of the seat pressure of the back pad 51, it can be expected to improve the efficiency of air conditioning by ventilation avoiding the range from HP100 to HP200 and the range from HP400 to HP600.

The number added after “HP” shown in FIG. 5 represents the distance (unit: [mm]) from the hip point H of the person P. The hip point H is a reference when the person P is seated on the seat 1. The hip point H can be interpreted as, for example, a rotation center point connecting the torso and the thigh of the AM50% ile dummy DP seated on the seat 1.

Specifically, HPO to HP100 is assumed to be a range of the seat back 5 corresponding to the first back portion P1 that supports the buttocks of the body. HP100 to HP200 is assumed to be a range of the seat back 5 corresponding to the second back portion P2 that supports the waist of the body. HP200 to HP300 is assumed to be a range of the seat back 5 corresponding to the third back portion P3 that supports the upper thoracic spine of the body. HP300 to HP400 is assumed to be a range of the seat back 5 corresponding to the fourth back portion P4 that supports the lower thoracic spine of the body. HP400 to HP500 is assumed to be a range of the seat back 5 corresponding to the fifth back portion P5 that supports the shoulder of the body. HP500 to HP600 is assumed to be a range of the seat back 5 corresponding to the sixth back portion P6 that supports the cervical spine of the body. More specifically, the upper thoracic spine of the present embodiment is assumed to be a range from the third thoracic vertebra to the seventh thoracic vertebra in the body. Further, the lower thoracic vertebra is assumed to be a range from the eighth thoracic vertebra to the 12th thoracic vertebra in the body.

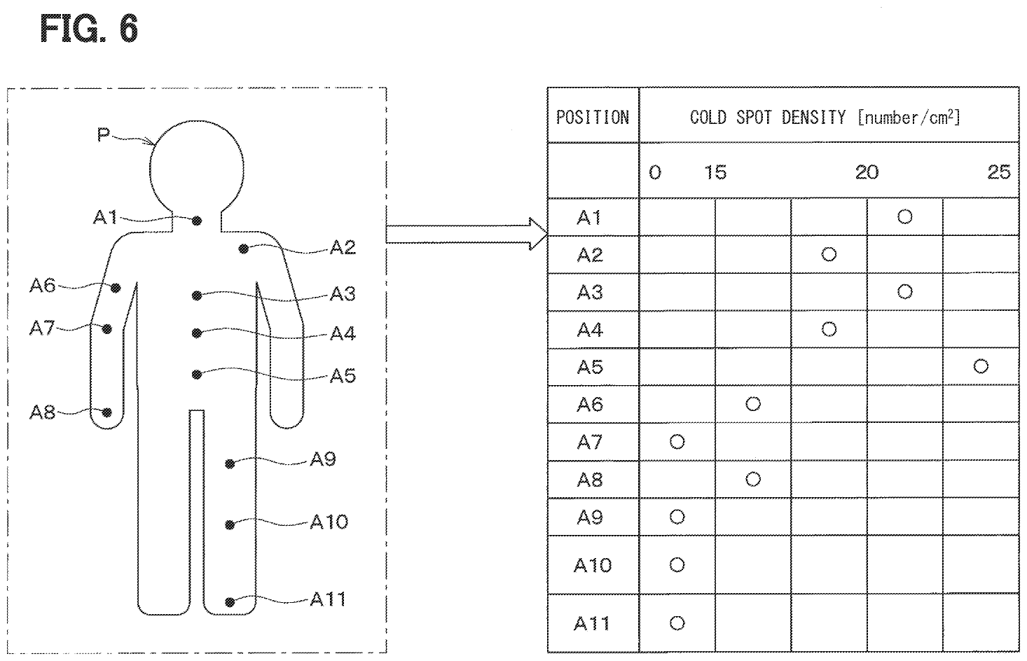

The cold spots for feeling cold are not uniformly distributed on the back surface of the body of the person P. For example, as shown in FIG. 6, the cold spots have a bias in location on the back surface of the body. The cold spot density is the number of cold spots per unit area.

As shown in FIG. 6, the cold spot density is relatively large in the cervical spine A1, shoulder A2, upper thoracic spine A3, lower thoracic spine A4, and waist A5 of the body. The cold spot density is relatively small in the upper arm A6, elbow A7, hand A8, thigh A9, knee A10, and leg A11.

Therefore, from the viewpoint of cold point density, it is expected to improve the efficiency of air conditioning by intensively ventilating the cervical spine A1, shoulder A2, upper thoracic spine A3, lower thoracic spine A4, and waist A5 of the body. In other words, from the viewpoint of cold point density, it can be expected to improve the efficiency of air conditioning by ventilating a range where the distance from the hip point H is 100 mm or more.

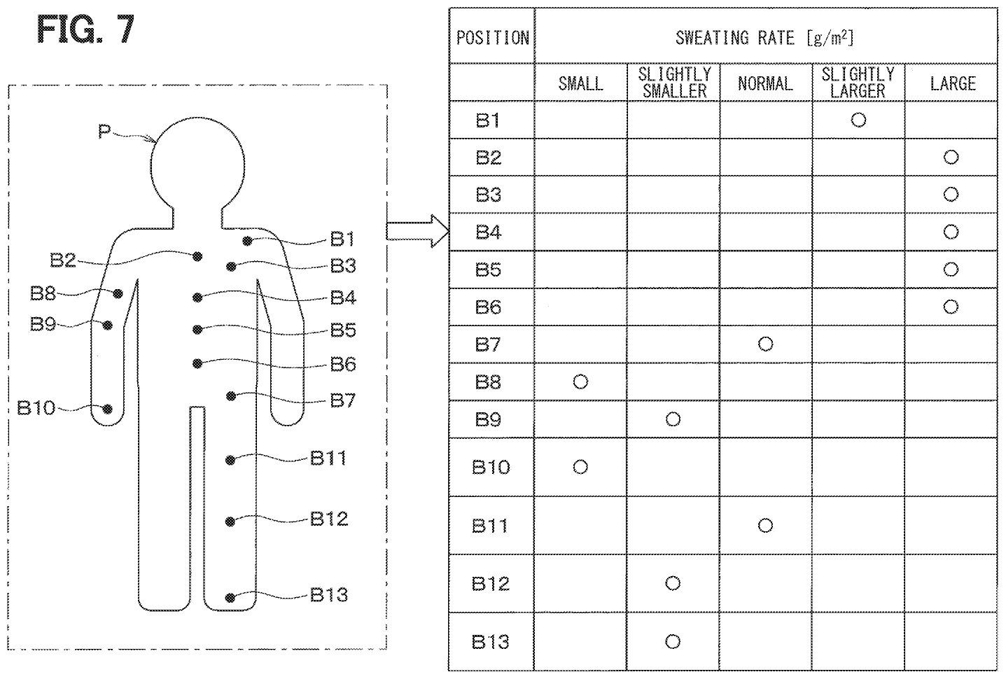

The sweating rate is not uniformly distributed on the back surface of the body of the person P. For example, as shown in FIG. 7, the sweating rate has a bias in location on the back surface of the body. The sweating rate is the amount of sweating per unit area under a predetermined environmental condition.

As shown in FIG. 7, the sweating rate is relatively large in the shoulder upper part B1, the shoulder middle part B2, the shoulder lower part B3, the upper thoracic spine B4, the lower thoracic spine B5, and the waist B6. The sweating rate is middle in the buttock B7 and the thigh B11. The sweating rate is relatively small in the upper arm B8, the elbow B9, the hand B10, the knee B12, and the leg A13.

Therefore, from the viewpoint of sweating rate, it is expected to improve the efficiency of air conditioning by intensively ventilating the shoulder middle part B2, the shoulder lower part B3, the upper thoracic spine B4, the lower thoracic spine B5, and the waist B6. In other words, from the viewpoint of sweating rate, it can be expected to improve the efficiency of air conditioning by ventilating a range where the distance from the hip point H is 100 mm or more.

The ventilation holes 510 of the present embodiment are formed unevenly in the range of HP200 to HP400 in the back pad 51 in consideration of the distribution of the seat pressure of the back pad 51, the distribution of the cold spot density, and the distribution of the sweating rate. That is, in the back pad 51, the area occupied by the ventilation holes 510 per unit area in the thoracic spine corresponding portion 51D corresponding to the third back portion P3 and the fourth back portion P4 is larger than the area occupied by the ventilation holes 510 in a portion other than the thoracic spine corresponding portion 51D. In other words, in the back pad 51, the area occupied by the ventilation holes 510 per unit area in the thoracic spine corresponding portion 51D corresponding the area from the lower part of the shoulder to the upper part of the waist of the dummy DP is larger than the area occupied by the ventilation holes 510 in a portion other than the thoracic spine corresponding portion 51D. In the present embodiment, the “occupied area of the ventilation hole 510” means the area occupied by the ventilation holes 510 per unit area on the surface of the back pad 51.

Specifically, as shown in FIG. 4, the back pad 51 has two ventilation holes 510A in the waist corresponding portion 51E corresponding to the second back portion P2 and two ventilation holes 510B in the shoulder corresponding portion 51F corresponding to the fifth back portion P5.

The thoracic spine corresponding portion 51D of the back pad 51 has eight ventilation holes 510C, 510D having an opening area similar to that of the ventilation holes 510A, 510B. More specifically, in the back pad 51, substantially six ventilation holes 510C are formed in the fourth back portion P4, and substantially two ventilation holes 510D are formed in the third back portion P3. As a result, in the back pad 51, the occupied area of the ventilation holes 510 in the fourth back portion P4 is larger than the occupied area of the ventilation holes 510 in the third back portion P3.

Further, in the back pad 51, the occupied area of the ventilation holes 510 per unit area in the center portion 51C corresponding to the center support 5C is larger than the occupied area of the ventilation holes 510 in the side portion 51A, 51B corresponding to the side support 5A, 5B. The ventilation holes 510 of the present embodiment are formed in the center portion 51C and not in the side portion 51A, 51B.

Further, the ventilation holes 510 of the present embodiment are formed so as to be biased to positions closer to the side portion 51A, 51B than a central position CL of the center portion 51C in the width direction.

Specifically, in the back pad 51, four ventilation holes 510 are formed along the lateral suspension groove 515 on the upper side, and three ventilation holes 510 are arranged along each of the vertical suspension grooves 513, 514.

At least a part of the four ventilation holes 510 formed along the lateral suspension groove 515 overlaps, for example, a range from the lateral suspension groove 515 to a position 20 mm away. Further, at least a part of the three ventilation holes 510 formed along the vertical suspension groove 513, 514 overlaps, for example, a range from the vertical suspension groove 513, 514 to a position 20 mm away. Many of the three ventilation holes 510 formed along the vertical suspension groove 513, 514 have oval hole shape.

The ventilation passage 511 on the back side of the back pad 51 is formed in concentrated manner, corresponding to the ventilation holes 510, in the vicinity of the thoracic spine corresponding portion 51D of the back pad 51, compared with the other portion other than the thoracic spine corresponding portion 51D.

In the seat air conditioner 10 configured in this way, when the blower 11 is driven, air is sucked from the manifold 512, as shown in FIGS. 2 and 3. As a result, the air on the front side of the seat back 5 is collected in the manifold 512 through the ventilation holes 510 and the ventilation passage 511, and then sucked into the blower 11 and discharged to the outside of the seat back 5.

In this way, if the air is sucked from the front side of the seat back 5, the heat of the seat back 5, which is hot at the initial stage when the person P gets on the vehicle, cannot be blown to the body, so that the cooling effect of the body can be improved. In addition, the cold air blown from the instrument panel at the front of the vehicle is sucked along the body of the person P, so that the cooling effect of the body can be further improved.

As described above, in the seat air conditioner 10, the area occupied by the ventilation holes 510 in the thoracic spine corresponding portion 51D corresponding to the third back portion P3 and the fourth back portion P4 is larger than the area occupied by the ventilation holes 510 in a portion other than the thoracic spine corresponding portion 51D. In other words, in the back pad 51, the occupied area of the ventilation holes 510 in the thoracic spine corresponding portion 51D corresponding to the lower part of the shoulder to the upper part of the waist of the dummy DP is larger than the occupied area of the ventilation holes 510 in a portion other than the thoracic spine corresponding portion 51D.

Accordingly, the ventilation capacity is raised in the portion supporting the thoracic spine from the lower part of the shoulder to the upper part of the waist where the cold spot density and the sweating rate are high in the seat back 5. In particular, the seat pressure is low and the flow of air is not easily obstructed in the thoracic spine corresponding portion 51D corresponding to the thoracic spine from the lower part of the shoulder to the upper part of the waist of the body, compared to the waist corresponding portion 51E corresponding to the waist having a high cold spot density and sweating rate of the body as in the thoracic spine. Further, since the thoracic spine corresponding portion 51D is closer to the seat back 5 than the shoulder corresponding portion 51F corresponding to the shoulder, it is easy to directly act the air flow on the body. As a result, according to the seat air conditioner 10 of the present embodiment, comfort can be efficiently given to the person P.

Specifically, in the back pad 51, the occupied area of the ventilation holes 510 in the fourth back portion P4 is larger than the occupied area of the ventilation holes 510 in the third back portion P3. The fourth back portion P4 has a lower seat pressure in the seat back 5 than the third back portion P3, so that the flow of air is less likely to be obstructed. Therefore, by increasing the occupied area of the ventilation holes 510 in the fourth back portion P4, it is possible to efficiently give comfort to the person P.

The fourth back portion P4 is closer to the head of the body than the third back portion P3. Therefore, if the ventilation holes 510 are concentrated on the fourth back portion P4, indirect air flow is likely to occur near the face including the forehead, cheeks, and chin where many cold spots are distributed. It is possible to give a further feeling of coldness for the person P.

Further, in the back pad 51, the occupied area of the ventilation holes 510 in the center portion 51C corresponding to the center support 5C is larger than the occupied area of the ventilation holes 510 in the side portion 51A, 51B corresponding to the side support 5A, 5B. The cold spot density and sweating rate is lower in the upper arm and elbow of the body supported by the side portion 51A, 51B than in the thoracic spine of the body supported by the center portion 51C. Therefore, it is possible to efficiently give comfort to the person P by making the occupied area of the ventilation holes 510 in the center portion 51C larger than the occupied area of the ventilation holes 510 in the side portion 51A, 51B.

Specifically, the ventilation holes 510 are formed in the center portion 51C and not in the side portion 51A, 51B. It is possible to realize efficient air conditioning with suppressed energy loss by concentrating the ventilation holes 510 on the center portion 51C in this way.

The ventilation holes 510 of the present embodiment are formed in the center portion 51C so as to be biased in location. Specifically, the ventilation holes 510 are positioned closer to the side portion 51A, 51B than the central position CL of the center portion 51C. In the center portion 51C, the seat pressure at the seat back 5 is lower at a position near the side portion 51A, 51B than at the center position CL of the center portion 51C, so that the flow of air is less likely to be obstructed. Therefore, it is possible to realize efficient air conditioning with suppressed energy loss by concentrating the ventilation holes 510 near the side portion 51A, 51B in the center portion 51C.

Further, it can give even more comfort by concentrating the ventilation holes 510 near the side portion 51A, 51B in the center portion 51C, since air flow is likely to occur in the vicinity of the armpit where sweat glands are concentrated in the body.

Further, the blower 11 of the present embodiment is arranged at a position where at least a part of the blower 11 overlaps the thoracic spine corresponding portion 51D in the thickness direction of the seat back 5. Accordingly, the blower 11 is located close to the thoracic spine corresponding portion 51D which occupies a large area of the ventilation holes 510, and the ventilation passage 511 can be shortened. Therefore, the pressure loss in the ventilation passage 511 is suppressed and the energy loss is suppressed to realize efficient air conditioning.

Further, if the ventilation passages 511 are formed in biased manner to a part of the back pad 51, it is not necessary to increase the thickness of the entire back pad 51 in order to form the ventilation passages 511, so that the weight can be reduced.

### Second Embodiment

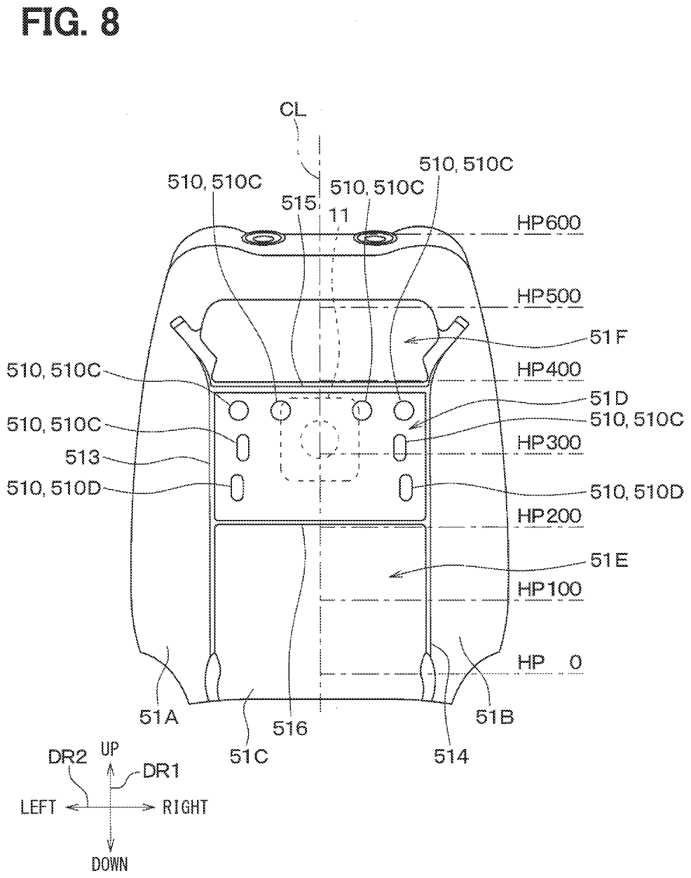

Next, a second embodiment of the present disclosure will be described with reference to FIG. 8. In the present embodiment, differences from the first embodiment will be mainly described.

As shown in FIG. 8, the ventilation holes 510 of the present embodiment are formed in concentrated manner in the range of HP200 to HP400 in the back pad 51. Specifically, the ventilation hole 510 is formed in the thoracic spine corresponding portion 51D corresponding to the third back portion P3 and the fourth back portion P4, and is not formed in a portion other than the thoracic spine corresponding portion 51D in the back pad 51. In other words, the ventilation hole 510 is formed in the thoracic spine corresponding portion 51D corresponding the area from the lower part of the shoulder to the upper part of the waist of the dummy DP, and is not formed in any portion other than the thoracic spine corresponding portion 51D.

The other configurations are similar to those of the first embodiment. The seat air conditioner 10 of the present embodiment can obtain the effects obtained from the same configuration or the uniform configuration as that of the first embodiment in the same manner as the first embodiment.

In the seat air conditioner 10 of the present embodiment, since the formation positions of the ventilation holes 510 are limited to the thoracic spine corresponding portion 51D, the person P is provided with comfort and the energy loss is significantly suppressed.

### (Modification to Second Embodiment)

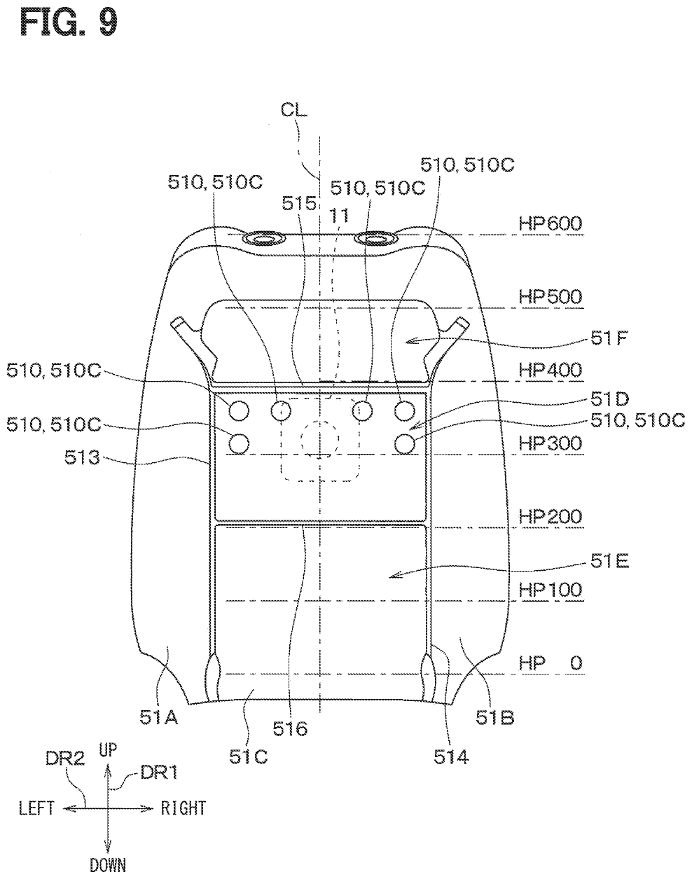

In the second embodiment, the ventilation hole 510 is formed in each of the third back portion P3 and the fourth back portion P4, but the formation position of the ventilation hole 510 is not limited to this. As shown in FIG. 9, the ventilation hole 510 may be formed only in the fourth back portion P4. Accordingly, since the formation position of the ventilation holes 510 is limited to a part of the thoracic spine corresponding portion 51D corresponding to the fourth back portion P4, the person P is provided with comfort and the energy loss can be greatly suppressed.

### OTHER EMBODIMENTS

Although representative embodiments of the present disclosure have been described above, the present disclosure is not limited to the embodiments described above, and various modifications can be made, for example, as follows.

As in the embodiment, it is desirable that the back pad 51 has the area occupied by the ventilation hole 510 in the fourth back portion P4 larger than the occupied area of the ventilation hole 510 in the third back portion P3. However, the formation position of the ventilation hole 510 is not limited to this. For example, the occupied area of the ventilation holes 510 in the fourth back portion P4 and the occupied area of the ventilation holes 510 in the third back portion P3 may be the same.

As in the embodiment, it is desirable that the occupied area of the ventilation holes 510 in the center portion 51C is larger than the occupied area of the ventilation holes 510 in the side portion 51A, 51B. However, the back pad 51 is not limited to this. For example, the occupied area of the ventilation hole 510 in the center portion 51C may be the same as the occupied area of the ventilation hole 510 in the side portion 51A, 51B.

As in the embodiment, it is desirable that the ventilation holes 510 are formed at a position closer to the side portion 51A, 51B than the central position CL of the center portion 51C. However, the formation position of the ventilation hole 510 is not limited to this. The ventilation hole 510 may be formed in the center portion 51C, for example, at a position closer to the central position CL than the side portion 51A, 51B.

As in the embodiment, it is desirable that the blower 11 is arranged at a position where at least a part of the blower 11 overlaps the thoracic spine corresponding portion 51D in the thickness direction of the seat back 5, but the blower 11 is not limited to be arranged in this position. The blower 11 may be arranged at a position that does not overlap the thoracic spine corresponding portion 51D in the thickness direction of the seat back 5.

In the embodiment, the vertical suspension groove 513, 514 and the lateral suspension groove 515, 516 of the back pad 51 hold the seams of the cover 52, but the seat back 5 is not limited to this. For example, the cover 52 and the back pad 51 may be integrally molded by foaming the constituent material of the back pad 51 inside the cover 52.

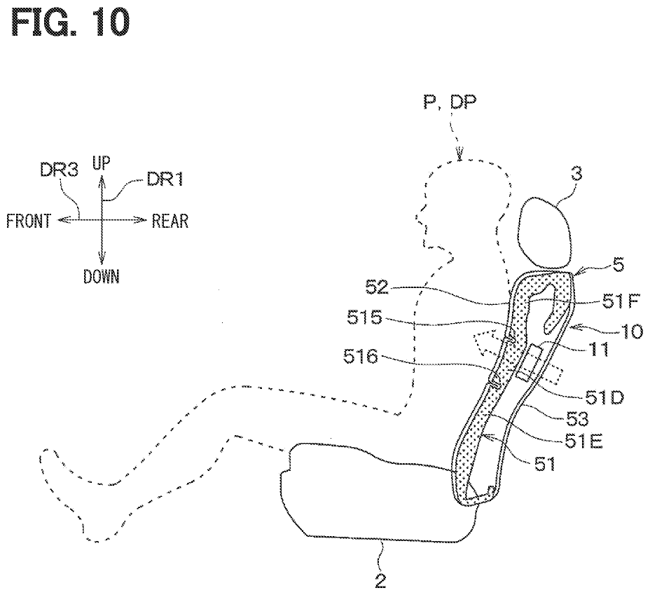

In the embodiment, the seat air conditioner 10 sucks air from the front side of the seat back 5, but the seat air conditioner 10 is not limited to this. For example, as shown in FIG. 10, the seat air conditioner 10 may blow out air to the front side of the seat back 5.

In the embodiment, the seat air conditioner 10 of the present disclosure is applied to the seat 1 installed in the vehicle, but the application target of the seat air conditioner 10 is not limited to this. The seat air conditioner 10 can be widely applied to, for example, stationary seats used in theaters, home, and the like.

In the embodiments, it goes without saying that the components constituting the embodiments are not necessarily indispensable unless otherwise clearly stated or unless otherwise thought to be clearly indispensable in principle.

In the embodiments, when a numerical value such as the number, a numerical value, an amount, or a range of the component of the embodiment is mentioned, the numerical value is not limited to the specified number unless otherwise specified to be indispensable or clearly limited to the specified number in principle.

In the embodiments, when a shape, a positional relationship, or the like of the component or the like is mentioned, the shape, the positional relationship, or the like is not limited to that being mentioned unless otherwise specified or limited to a specified shape, a specified positional relationship, or the like in principle.

According to the first aspect shown in part or all of the above embodiments, a seat air conditioner includes a blower and a seat back that supports an upper body of a person.

The seat back has an air-permeable cover placed on the front side, which is the support surface for supporting the upper body of the person, and a back pad having ventilation holes on the front side through which the air flows toward the blower. The back pad has a ventilation passage in communication with the ventilation holes. In the back pad, the occupied area of the ventilation hole per unit area in the thoracic spine corresponding portion corresponding to the third back portion and the fourth back portion of the seat back is larger than the occupied area of the ventilation hole in a portion other than the thoracic spine corresponding portion.

According to the second aspect, in the back pad, the occupied area of the ventilation hole in the fourth back portion is larger than the occupied area of the ventilation hole in the third back portion. Compared to the third back portion, the fourth back portion has a lower seat pressure in the seat back, and the flow of air is less likely to be obstructed. Therefore, it is possible to efficiently give comfort to the person by increasing the occupied area of the ventilation hole in the fourth back portion.

According to the third aspect, a seat air conditioner includes a blower for generating an air flow and a seat back for supporting an upper body of a person. The seat back has a breathable cover arranged on the front side, which is a support surface for supporting the upper body, and a back pad having ventilation holes for the air flow generated by the blower on the front side. A ventilation passage is formed in the back pad and is connected to the ventilation holes. In the back pad, the occupied area of the ventilation hole per unit area in the thoracic spine corresponding portion corresponding to the lower part of the shoulder to the upper part of the waist of the AM50% ile dummy, which is a human body model of the person, is larger than the occupied area of the ventilation holes in a portion other than the thoracic spine corresponding portion.

According to the fourth aspect, the ventilation holes are formed in the thoracic spine correspondence portion and not in the other portion. In this way, it is possible to realize efficient air conditioning with suppressed energy loss by concentrating the ventilation holes in the thoracic spine corresponding portion.

According to the fifth aspect, the seat back has side supports that support the person from the width direction of the seat back, and a center support arranged between the side supports. In the back pad, the occupied area of the ventilation hole per unit area in the center portion corresponding to the center support is larger than the occupied area of the ventilation hole in the side portion corresponding to the side supports. The upper arm and elbow of the body supported by the side portion have lower cold spot density and lower sweating rate than the thoracic spine of the body supported by the center portion. Therefore, it is possible to efficiently give comfort to the person by increasing the occupied area of the ventilation hole at the center portion.

According to the sixth aspect, the ventilation holes are formed in the center portion and not in the side portion. In this way, it is possible to realize efficient air conditioning with suppressed energy loss by concentrating the ventilation holes in the center portion.

According to the seventh aspect, the ventilation holes are formed in the center portion as biased in location, specifically, at a position closer to the side portion than the central position of the center portion. In the center portion, the seat pressure at the seat back is lower and the air flow is less likely to be obstructed near the side portion than at the center position of the center portion. Therefore, it is possible to realize efficient air conditioning with suppressed energy loss by concentrating the ventilation holes near the side portion in the center portion.

According to the eighth aspect, the blower is arranged at a position where at least a part of the blower overlaps the thoracic spine corresponding portion in the thickness direction of the seat back. Accordingly, the blower is located close to the thoracic spine corresponding portion in which the area occupied by the ventilation hole is large and the ventilation passage can be shortened. Therefore, it is possible to realize efficient air conditioning, since the pressure loss in the ventilation passage is suppressed and the energy loss is suppressed.

What is claimed is:

1. A seat air conditioner comprising:
a blower configured to generate an air flow; and
a seat back configured to support an upper body of a person, wherein the seat back includes
a cover, which is air-permeable, arranged on a front side to support the upper body of the person, and
a back pad having a plurality of ventilation holes on the front side through which the air flow generated by the blower passes, and a ventilation passage connected to the plurality of ventilation holes,
when a part of the seat back exposed to the person is evenly divided into a first back portion, a second back portion, a third back portion, a fourth back portion, a fifth back portion and a sixth back portion in this order from a lower side, the back pad has a thoracic spine corresponding portion corresponding to the third back portion and the fourth back portion, and
an area occupied by the ventilation hole per unit area in the thoracic spine corresponding portion is larger than an area occupied by the ventilation hole in a portion other than the thoracic spine corresponding portion.

2. The seat air conditioner according to claim 1, wherein an area occupied by the ventilation hole in the fourth back portion is larger than an area occupied by the ventilation hole in the third back portion, in the back pad.

3. A seat air conditioner comprising:
a blower configured to generate an air flow; and
a seat back configured to support an upper body of a person, wherein the seat back includes
a cover, which is air-permeable, arranged on a front side to support the upper body of the person, and
a back pad having a plurality of ventilation holes on the front side through which the air flow generated by the blower passes, and a ventilation passage connected to the plurality of ventilation holes,
when an upper body of an AM50% ile dummy, which is a human body model of the person, is supported by the seat back, the back pad has a thoracic spine corresponding portion corresponding to an area from a lower part of a shoulder to an upper part of a waist of the AM50% ile dummy, and
an area occupied by the ventilation hole per unit area in the thoracic spine corresponding portion is larger than an area occupied by the ventilation hole in a portion other than the thoracic spine corresponding portion.

4. The seat air conditioner according to claim 3, wherein the plurality of ventilation holes is formed in the thoracic spine corresponding portion and is not formed in the portion other than the thoracic spine corresponding portion.

5. The seat air conditioner according to claim 3, wherein
the seat back has side supports that support the person in a width direction of the seat back, and a center support arranged between the side supports, and
an area occupied by the ventilation hole per unit area in a center portion of the back pad corresponding to the center support is larger than an area occupied by the ventilation hole in a side portion of the back pad corresponding to the side supports.

6. The seat air conditioner according to claim 5, wherein the plurality of ventilation holes is formed in the center portion and not formed in the side portion.

7. The seat air conditioner according to claim 5, wherein the plurality of ventilation holes in the center portion is biased in position so as to be located closer to the side portion than a center position of the center portion.

8. The seat air conditioner according to claim 5, wherein the blower is arranged at a position overlapping with the thoracic spine corresponding portion in a thickness direction of the seat back.
